(19) United States
(12) Patent Application Publication
(10) Pub. No.: US 2025/0233690 A1
(43) Pub. Date: Jul. 17, 2025

(54) NETWORK TRAFFIC REGULATOR DETECTION AND MITIGATION

(71) Applicant: Netflix, Inc., Los Gatos, CA (US)

(72) Inventors: Randall Ray Stewart, Bella Colina, FL (US); Grenville John Armitage, Surrey Hills (AU); Lawrence Aloysius Honore Stewart, Mont Albert (AU); Veronica Adelle Hannan, San Francisco, CA (US)

(21) Appl. No.: 19/016,510

(22) Filed: Jan. 10, 2025

Related U.S. Application Data
(60) Provisional application No. 63/620,587, filed on Jan. 12, 2024.

(51) Int. Cl. H04L 1/08; H04L 5/00

(52) U.S. Cl. CPC H04L 1/08; H04L 5/0055

(57) ABSTRACT

The disclosed computer-implemented method includes determining, for a network connection, an amount of bandwidth at which data has been transferred starting from a specified point in time. The method next includes identifying network heuristics related to occurrences of data packet retransmissions on the network connection since the specified point in time. The method also includes determining, based on the network heuristics, that a maximum threshold value for data packet retransmissions has been exceeded. The method further includes updating a network transmission bucket maximum size to an amount of data that was acknowledged, using one or more acknowledgment (ACK) messages, since the specified point in time. Various other methods, systems, and computer-readable media are also disclosed.

### CROSS REFERENCE TO RELATED APPLICATIONS

This application claims priority to and the benefit of U.S. Provisional Patent Application No. 63/620,587, filed on Jan. 12, 2024, which application is incorporated by reference herein in its entirety.

### BACKGROUND

Wired and wireless networks transmit data to computing devices all over the world. These devices implement data transfer protocols to transfer the data. The data transfer protocols are designed to ensure that any data that is transmitted is ultimately received by the end device (e.g., a mobile phone). Due to a variety of factors, however, data packets are often lost during the transmission between the source and the destination.

In some cases, for instance, packet loss may be due to network traffic regulators. Network traffic regulators are, at least in some cases, implemented to determine whether a network node is transmitting data packets in an excessive manner. In such cases, the network traffic regulator may determine that the network traffic from a particular node is excessive and may then enforce limits on the connection. These limits, in turn, may result in intentional packet loss, which is often compensated by retransmitting packets. Such retransmissions are burdensome on network hardware and consume resources unnecessarily.

### SUMMARY

The embodiments herein include systems and methods for detecting when network traffic regulators are being used on a network and taking steps to mitigate the involvement of network traffic regulators. Reducing the involvement of such regulators may, in turn, reduce the number of data packets that are (intentionally) dropped and that then need to be retransmitted. Avoiding the involvement of network traffic regulators reduces the burden on data transmission networks and frees up network bandwidth for other users and other software applications.

In some examples, a computer-implemented method is provided that includes determining, for a network connection, an amount of bandwidth at which data has been transferred starting from a specified point in time. The method next includes identifying various network heuristics related to occurrences of data packet retransmissions on the network connection since the specified point in time. The method further includes determining, based on the network heuristics, that a maximum threshold value for data packet retransmissions has been exceeded. The method also includes updating a network transmission bucket maximum size to an amount of data that was acknowledged, using one or more acknowledgment (ACK) messages, since the specified point in time.

In some cases, prior to determining the amount of bandwidth at which data has been transferred, the method includes determining that a network connection was previously labeled as being monitored by a network traffic regulator. In some examples, the method further includes accessing information related to the network connection, where the information includes at least an indication of when the network connection was started or an indication of whether network traffic regulations had previously been enforced on the network connection.

In some embodiments, the method further includes determining a data packet retransmission rate starting from the specified point in time, an average number of times a data packet is being retransmitted on the network connection, and/or a median number of times a data packet is being retransmitted on the network connection. In some cases, maximum threshold values are established for the data packet retransmission rate, the average number of retransmissions, and/or the median number of retransmissions. In some examples, the method further includes comparing the data packet retransmission rate, the average number of retransmissions, and the median number of retransmissions to the corresponding maximum threshold values. Then, upon determining that two or more of the three or all three are greater than the maximum threshold values, declaring that the network connection is being regulated by a network traffic regulator.

In some cases, the data that was acknowledged includes network data starting from a last idle time to the beginning of a recovery time. In some examples, the method further includes validating that a set number of packets have been delivered during the recovery time. In some embodiments, updating the network transmission bucket maximum size to the amount of data that was acknowledged includes updating traffic regulator bandwidth to a value that allows a pacing timer to expire before a transmission round trip occurs. In some cases, the transmission round trip comprises a smoothed round trip time (SRTT) for the network data packets. In some embodiments, the method further includes mitigating data packet retransmission by modifying a rate of token bucket filling, by modifying a data transmission size, or by specifying a pacing rate for a network traffic regulator.

In addition to the above-described method, a network system is provided that includes a network adapter that transmits and receives data via a transport protocol, a memory device that at least temporarily stores data received at the network adapter, and a processor that processes at least some of the received data, including: determining, for a network connection, an amount of bandwidth at which data has been transferred starting from a specified point in time, identifying network heuristics related to occurrences of data packet retransmissions on the network connection since the specified point in time, determining, based on the network heuristics, that a maximum threshold value for data packet retransmissions has been exceeded, and updating a network transmission bucket maximum size to an amount of data that was acknowledged, using various acknowledgment (ACK) messages, since the specified point in time.

The embodiments herein also include a non-transitory computer-readable medium that includes computer-executable instructions that, when executed by at least one processor of a computing device, cause the computing device to: determine, for a network connection, an amount of bandwidth at which data has been transferred starting from a specified point in time, identify network heuristics related to occurrences of data packet retransmissions on the network connection since the specified point in time, determine, based on the network heuristics, that a maximum threshold value for data packet retransmissions has been exceeded, and update a network transmission bucket maximum size to an amount of data that was acknowledged, using various acknowledgment (ACK) messages, since the specified point in time.

Features from any of the embodiments described herein may be used in combination with one another in accordance with the general principles described herein. These and other embodiments, features, and advantages will be more fully understood upon reading the following detailed description in conjunction with the accompanying appendices.

### BRIEF DESCRIPTION OF THE DRAWINGS

The accompanying appendices illustrate a number of exemplary embodiments and are a part of the specification. Together with the following description, these appendices demonstrate and explain various principles of the present disclosure.

FIG. 1 illustrates a computing environment in which the embodiments described herein operate.

FIG. 2 illustrates a flow diagram of a method for monitoring and mitigating data packet retransmissions.

FIG. 3 illustrates a computing environment in which data is transferred between an internet service provider and an end device.

FIG. 4 illustrates a computing environment in which a network traffic regulator is detected.

FIG. 5 illustrates an embodiment of different maximum data packet retransmission threshold values.

FIG. 6 illustrates a timeline measured from a last idle time to a recovery time and beyond.

FIG. 7 illustrates an embodiment of different mitigation responses that may be used upon detecting a network traffic regulator.

FIG. 8 is a block diagram of an exemplary content distribution ecosystem.

FIG. 9 is a block diagram of an exemplary distribution infrastructure within the content distribution ecosystem shown in FIG. 8.

FIG. 10 is a block diagram of an exemplary content player within the content distribution ecosystem shown in FIG. 9.

Throughout the appendices, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

The present disclosure is generally directed to monitoring and mitigating data packet retransmissions. In some cases, network traffic regulators are detected and planned for using a variety of techniques.

As noted above, wired and wireless networks transmit data to computing devices all over the world. These devices implement data transfer protocols to transfer the data. The data transfer protocols are designed to ensure that any data that is transmitted is ultimately received by the end device (e.g., a mobile phone, television, laptop, etc.). Due to various factors, however, data packets are often lost or even intentionally removed from the data stream during the transmission between source and destination device.

In some cases, for instance, data packets are intentionally removed from a network stream by a network traffic regulator. Network traffic regulators may be implemented to determine when a network node is transmitting data packets too often or in too high of a quantity. In such cases, the network traffic regulator determines that the network traffic from a particular node is excessive and then begins to restrict the number of data packets that can be sent by that node. The restriction may take the form of dropping some, but not all, of that node's data packets. . . . Because each network may instantiate different network traffic regulation actions, network protocols or devices do not know how to optimally react when a network traffic regulator is acting on a network connection.

The embodiments herein use various techniques to detect when a network traffic regulator is being used. Once a network traffic regulator has been detected on a connection, the systems herein begin to look at different criteria to determine data transmission parameters that would avoid the network traffic regulator's action(s). For example, data is often transferred from a server to a client device in packets. Receipt of these data packets at the client device is acknowledged by sending an acknowledgement (ACK) message to the server. The ACK indicates that data packets up to a specified point have been received, and the amount of acknowledged data per unit time is a measure of a connection's data transmission rate. In some cases, network traffic regulators use “token buckets” to track the server's data transmission rate, by deducting tokens as data traverses the regulation point and replenishing tokens at a configured rate. When the bucket runs out of tokens, a regulatory action will be applied (e.g., by dropping data packets) until new tokens become available. The server can estimate the traffic regulator's token bucket size and replenishment rate by measuring the amount of acknowledged data over different measurement periods. The embodiments herein are designed to infer the network traffic regulator's configuration through empirical observation of data transmissions. The systems herein can then attempt to match a sending device's data transmission to the network regulator's imposed requirements. In some cases, for example, the systems herein will determine an optimal bucket size that will reset before the network traffic regulator steps in and begins dropping packets.

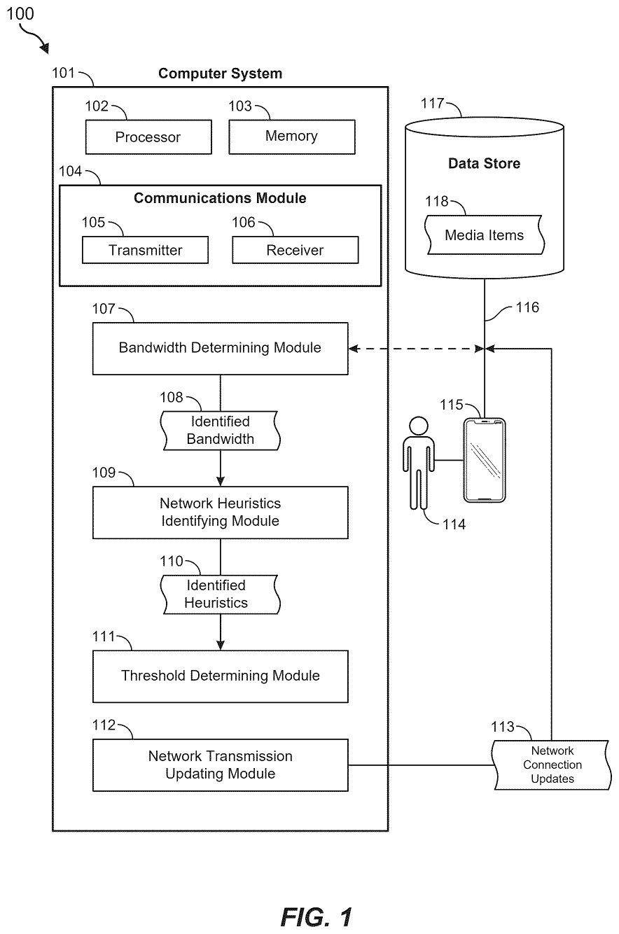

FIG. 1 illustrates a computing environment 100 that includes a computing system 101. The computing system 101 may be substantially any type of computing system including a local computing system or a distributed (e.g., cloud) computing system. The computing system 101 may include at least one processor 102 and at least some system memory 103. The computer system 101 may include program modules for performing a variety of different functions. The program modules may be hardware-based, software-based, or may include a combination of hardware and software. Each program module may use computing hardware and/or software to perform specified functions, including those described herein below.

The computing system 101 also includes a communications module 104 that is configured to communicate with other computer systems. The communications module 104 may include any wired or wireless communication means that can receive and/or transmit data to or from other computer systems. These communication means may include hardware interfaces including Ethernet adapters, WIFI adapters, hardware radios including, for example, a hardware-based transmitter 105, a hardware-based receiver 106, or a combined hardware-based transceiver capable of both receiving and transmitting data. The radios may be cellular radios, Bluetooth radios, global positioning system (GPS) radios, or other types of radios. The communications module 104 may be configured to interact with databases, mobile computing devices (such as mobile phones or tablets), embedded or other types of computing systems.

The computing system 101 also includes a bandwidth determining module 107. The bandwidth determining module 107 is configured to determine an amount of bandwidth at which data has been transferred starting from a specified point in time. In order to determine whether a network traffic regulator is being used to monitor and regulate a data transmission (e.g., 116) between two parties (e.g., between data store 117 (e.g., serving media items 118) and a computing device 115 belonging to an end user 114), the systems herein first determine an amount of bandwidth at which data has been transferred since a connection started, for example, or since the last acknowledgement (ACK) message was received by the data store (or since the beginning of another specified starting point).

The identified bandwidth 108 (e.g., measured in bytes/second or kilobytes/second, megabytes/second, gigabytes/second, or more) is then used, by the network heuristics identifying module 109, to identify network heuristics 110 related to occurrences of data packet retransmissions on the network connection 116 since the specified point in time. For instance, the systems herein may look at data packet retransmission rates, an average number of data packet retransmissions, a median number of data packet retransmissions, or other network heuristics.

The data packet retransmission rate indicates how many data packets, of the total packets transferred, are retransmitted during the connection. As implied by the name, the average number of data packet retransmissions indicates the average number of data packets that are retransmitted during a specified timeframe (e.g., over the last 10 min., 60 min., the last day, week, etc., or over a time since the connection started or since the last ACK message was sent/received, etc.). The median number of data packet retransmissions indicates the median number of data packets that are retransmitted during the specified timeframe (which can be any of the above-identified timeframes or a different, defined timeframe). These (and potentially other) identified heuristics 110 are used to determine whether the network connection 116 is excessively retransmitting data packets that is likely caused by a network traffic regulator.

The computing environment 100 of FIG. 1 further includes a threshold determining module 111. The threshold determining module 111 is configured to determine, based on the identified network heuristics 110, that a maximum threshold value for data packet retransmission has been exceeded. For instance, the network heuristics 110 may specify a typical or unexceptional amount of data packet retransmission for network connection 116. If the connection is retransmitting beyond the maximum threshold value for packet retransmission rate or volume, the computer system 101 may determine that the network connection 116 is being regulated by a network traffic regulator.

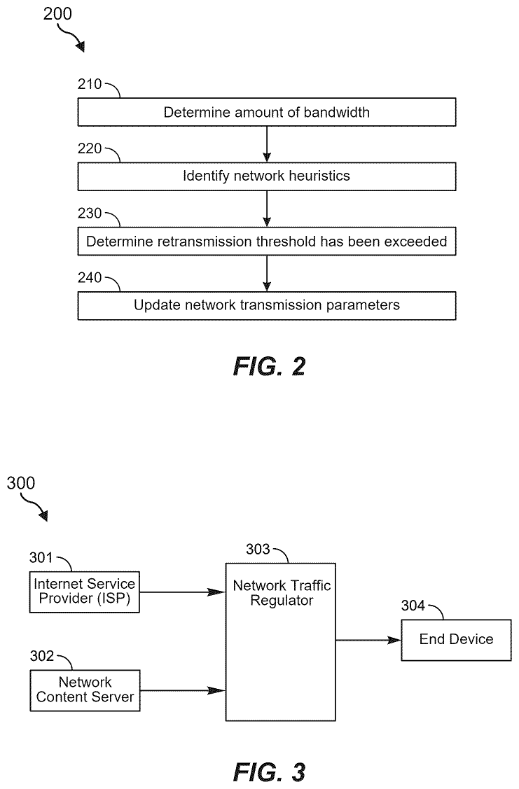

At least in some embodiments, the network transmission updating module 112 then updates a network transmission bucket maximum size (e.g., using network connection updates 113) to the amount of data that was acknowledged (using ACK messages) since the point in time that was specified earlier. By changing the transmission bucket size to the amount of data that was acknowledged (and not to a larger amount), the network connection 116 will stay below the transmission rate at which the network traffic regulator intervenes, thereby avoiding the packet loss that would be caused by the network traffic regulator and avoiding consequent data packet retransmissions. This process will be described in greater detail below with regard to method 200 of FIG. 2 and FIGS. 3-10 below.

FIG. 2 is a flow diagram of an exemplary computer-implemented method 200 for monitoring and mitigating data packet retransmissions. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below.

Method 200 includes, at 210, a step for determining, for a network connection, an amount of bandwidth at which data has been transferred starting from a specified point in time. Method 200 next includes identifying, at 220, various network heuristics related to occurrences of data packet retransmissions on the network connection since the specified point in time. Method 200 further includes determining, at 230 and based on the network heuristics, that a maximum threshold value for data packet retransmissions has been exceeded. Method 200 also includes updating, at 240, a network transmission bucket maximum size to an amount of data that was acknowledged, using one or more acknowledgment (ACK) messages, since the specified point in time.

The method 200 may be implemented not only to detect network traffic regulators, but also to mitigate the effect these regulators have on network connections. While many of the embodiments presented herein are described in terms of Transmission Control Protocol (TCP) connections, it will be recognized that substantially any type of communications protocol that is capable of inferring packet drop rate (i.e., inferring the network regulator's enforcement rate), and is capable of modulating its transmission rate, may be used. Such communications protocols may include Stream Control Transmission Protocol (SCTP), QUIC, or other protocols. These embodiments outline how the systems herein detect the possibility of a network traffic regulator on a network connection. Once a network traffic regulator has been detected, the systems herein initiate a mitigation phase. At least in some cases, these systems continue detecting the influence of network traffic regulators during the mitigation phase.

Network connections are initialized with the network traffic regulator's token bucket being “full” of tokens. For example, in some cases, one token would be equivalent to one byte of data, where an internet data packet may be 1500 bytes. Each packet passing through the network traffic regulator consumes some number of tokens, and at some periodicity, the network traffic regulator adds tokens back to the bucket (capped at the bucket size limit).

At least in some cases, the average rate a connection can send data at to avoid regulatory action is determined by the token replenishment rate (r). That said, however, on short timescales, a network connection can send data at higher rates than (r) until such time as the bucket runs out of tokens. At that point, all subsequent packets are dropped until fresh tokens are added to the bucket. The embodiments described herein infer, on the data transmitting device, what the regulator's token replenishment rate (r) is and what the bucket size is in bytes. In that manner, the transmitting device can then modulate its transmission rate to avoid triggering a “drop” action by the network traffic regulator.

As noted above, at least in some embodiments, the systems herein establish thresholds for detecting network traffic regulators. In some cases, such detection can be turned off or on by a network administrator. In such cases, the detection is turned on/off for a specified TCP connection, regardless of which network hardware devices or components are implemented to transmit the data. In such cases, a connection-specific socket option is used to initiate the detection process. Within the connection-specific socket option, a URL parameter “N” is provided, where N is a bit encoded number that specifies various values (e.g., three values).

In one embodiment, the bit-encoded number specifies three values: a median threshold value (e.g., “median_threshold”) representing the median number of times it takes to retransmit a data packet during a recovery incident, an average threshold value (e.g., “average_threshold”) representing the average number of times a packet is retransmitted during a recovery incident, and a retransmit threshold (e.g., “retransmit_threshold”) representing the average retransmit rate since the start of a connection or the last time the connection was declared to be regulated.

At least in some embodiments, the median threshold is an integer number between 1-16 that represents the median number of times it takes to retransmit a packet during one recovery incident. For a given “rack stack” that represents a particular packet loss and retransmission heuristic, each time the rack stack enters recovery for packet loss identified by the packet loss and retransmission heuristic, the stack clears an array of 16 integers. These integers represent the count of times a single packet is retransmitted, where the 0th integer indicates how many times a packet had to be retransmitted one time, and the 14th integer in the array indicates how many packets were retransmitted 15 times, and the last element in the array (15) represents how many packets were retransmitted 16 or more times. Thus, at any detection point, the systems herein can examine this array and establish the median value for retransmits between 1-16 (or some other value). The median is established by totaling up the array counts and then dividing the total by two. The system then walks through the array of values, adding up how many packets have been sent until the system reaches one half of the established total.

Additionally or alternatively, another detection threshold can be set via changes to one or more URL parameters. This value, unlike the three values above, may include an initial value of 18. This value represents the number of packets that must have been delivered during recovery in order for the network traffic regulator detection algorithms to be enabled. In some cases, setting this value to zero disables the check for bytes delivered in recovery, as described further below.

Detecting network traffic regulators may be performed in multiple places or at different times in a network stack. For example, at least in some scenarios, detection of a network traffic regulator is performed whenever a RACK timer expires or at the end of a packet loss recovery phase. In some cases, detection of a network traffic regulator when a RACK timer expires is performed only if the underlying system has not classified the network connection (e.g., 116) as being monitored or regulated. Once the system has decided that a connection is being regulated, RACK timer expirations will no longer initiate the regulator detection logic.

In at least some embodiments, the underlying system only initiates the regulator detection based on the timer expiration to attempt to speed up detection. Once the system has detected use of a regulator, the system uses the end of recovery to update any parameters deduced previously (e.g., in ongoing detection, described further below). At least in some cases, the system calls into the detection algorithm when the recovery phase ends. This call into the regulator detection logic will update two (or more) metrics established by the system and maintain these metrics in the detection logic (e.g., network traffic regulator bandwidth, or “bucket refill rate,” and the maximum network traffic regulator bucket size). These two values aid the system during mitigation to avoid triggering the network traffic regulator and, as a result, cause packets to be dropped.

The embodiments described herein perform multiple tasks to determine whether a connection is being regulated and, if so, to establish or update one or more network connection metrics or heuristics. In some cases, the system described herein determines whether the network connection (e.g., 116) has been declared or identified as being monitored. If the connection has already been identified as being regulated by a network traffic regulator, the system validates that a set number of messages has been delivered during the recovery phase. This number of bytes delivered so far during recovery is translated into a number of messages delivered during recovery. If the threshold set is larger than the number of packets delivered during recovery, the system stops detection and returns. This prevents small recovery episodes from establishing a network traffic regulator is being used on the connection 116.

Next, the system establishes the bandwidth at which it has delivered data in the past (e.g., since the start of the connection, or in the last X number of minutes, etc.). The system takes the number of bytes delivered so far in the recovery process and divides that number of bytes by the time spent in the recovery process. This delivery rate counts all bytes acknowledged via selective ACK (SACK) messages or via cumulative acknowledgement messages.

The system next checks to determine whether a network traffic regulator bandwidth has been established. If so, the system checks if the pacing interval derived from the established bandwidth is less than the current smoothed round trip time (SRTT). If it is not, the established network traffic regulator bandwidth is adjusted to ensure the derived pacing interval is less than the SRTT. This adjustment improves the performance of low bandwidth connections falsely detected as being subject to network traffic regulation.

The system then establishes the retransmit rate based on what has been sent and resent since the last positive network traffic regulator detection (or since the start of the network connection if the system has never detected a network traffic regulator). In some cases, this is the average number of times a packet is retransmitted.

If the calculated median works out to be a maximum value (e.g., 16) then the median number of retransmits would indicate a network connection breakage, and not a network traffic regulator action. As such, this connection would not be considered to be regulated by a network traffic regulator. If the determination is incorrect, then the system will come back when the network traffic regulator is letting data through and check the established thresholds. With these current values established, the system then compares the current values to the previously established thresholds. At least in some cases, if some or all (three) of these values are greater than or equal to their respective thresholds, the system will declare that the network connection is being regulated and will initiate a mitigation process.

The mitigation process will record the current sent byte levels and retransmitted byte levels to compare for a future retransmit rate. The system then sets the network traffic regulator bandwidth based on the established delivery rate up to a specified point during recovery.

The system sets the policer bucket maximum size to the amount of data that was acknowledged from an arbitrarily set point in time (e.g., from the last idle to the beginning of recovery or simply from X specified time to Y specified time, where Y is later than X). The maximum bucket size sets a limit on how far the bucket grows. At least in some cases, the calculated bucket size is set to 0 each time recovery is entered. The system also sets the bucket size to 0 if this is the first time the system is declaring that a network traffic regulator is active on the network connection. And, in some cases, if, instead of hitting the established thresholds that cause the system to exit recovery and the system has detected a network traffic regulator on the network path, the system goes into an update process that updates the bucket maximum size if the calculated value is larger than the current bucket maximum size. If the system were in recovery for at least one round trip (e.g., as indicated by an SRTT or other estimate of round-trip time), the system would update the network traffic regulator bandwidth, if it is larger than the previous amount established.

Mitigation may take on multiple distinct phases as the system attempts to output data to a peer (e.g., an end device). These phases include bucket filling, send sizing, and policer pacing rate. For the bucket filling phase, the system checks if network traffic regulator detection logic is operating and if the system has established that the network connection is being regulated. If this is true, and the connection is being regulated, the system calculates the amount of time that has transpired since the last send. This time is then used in conjunction with the network traffic regulator bandwidth amount to add tokens to the current bucket size. The current bucket, however, is restricted to not grow above the previously established policer maximum bucket size. The current bucket size then indicates how many bytes the system currently surmises that the network traffic regulator will allow the connection to send. The system then calculates the rate at which the current bucket size could be sent without triggering the network traffic regulator.

Once the system detects a regulated network connection, the system establishes the send quantum (amount of data that can be sent during a single send operation, whether during transmission or retransmission). Once that amount of data has been established, the amount of data that is to be transmitted is determined. As part of this process, the systems herein determine the length of the messages that are to be transmitted. In some cases, these systems determine various characteristics of the messages, including potentially identifying an indication of how much more data may be needed in the token bucket to transmit the messages (e.g., a number of bytes, such as an integer number) that can be sent. This indication of how much more data is needed in the token bucket is based on the current bucket size determined previously. Once the current bucket size is within a specified percent of being empty, then the system only allows sending a pacer-defined, maximum number of bytes and controls the pacing rate of the output to match the network traffic regulator's bandwidth by setting a network traffic regulator pacer flag. If there are not enough bytes in the current token bucket, the system will return a zero value and fill in a “more data needed” pointer indicating how many more bytes the bucket needs before the system can send at least a pacer-defined minimum (or target) send.

If zero is returned by the system at this point, then, at least in some cases, no data will be sent. And, instead, a pacing timer will be started based on the number of byte tokens that are to be added to the current token bucket and the network traffic regulator bandwidth established previously. If the system then transmits the message, the transmission will proceed as normal except when a network traffic regulator pacer flag is set, the pacing timer returned by the system is overridden to match the length and/or bandwidth that the network traffic regulator will allow through (i.e., the pacing timer will run long enough to allow what was previously sent to be sent again).

Once network traffic regulator detection has been activated, the system continues to implement a network traffic regulator detection function at the end of each recovery phase. At least in some cases, the system implements the same or similar detection logic described above. As such, if the system has transmitted too much data and has triggered a network traffic regulator on the connection, the system will reset the thresholds to a default set of values or to a specified set of values (e.g., the values initially established when the network traffic regulator was detected on the network path).

If the system does not reach or exceed the established thresholds, then the system will enter an update mode which may then vary the network traffic regulator bucket size and/or the network traffic regulator bandwidth. These actions help the system recover from either a false positive by letting the network traffic regulator bucket continue to grow, so a false positive will be less constricting on a connection. And, the opposite is true, where if the system, over time, has increased the network traffic regulator bucket to a size that is too large and the connection is again being actively regulated, these actions will reduce the bucket size and/or bandwidth values to values that will avoid regulation.

Turning now to FIG. 3, an illustration is provided of a computing environment 300 in which data is transferred between an internet service provider (ISP) 301 and an end device 304 or between a network content server 302 and an end device 304. The ISP may be configured to receive data requests and transfer data through wired and/or wireless networks. In some cases, the data requested by a user may be for media content or other types of content (e.g., personal data such as word processing documents, spreadsheets, slide decks, notes, personal photos, application backup data, etc.) stored on a network content server 302. The network content server 302 may be configured to store and provision movies, television shows, video clips, audio clips, songs, or other media files to requesting end devices (e.g., 304). During this provisioning process between the network content server 302 and the end device 304 (e.g., a smartphone, tablet, smartwatch, laptop, PC, or other computing device), a network traffic regulator 303 may monitor and/or regulate the data transfer if the amount and/or rate of transmitted data on the connection is too high.

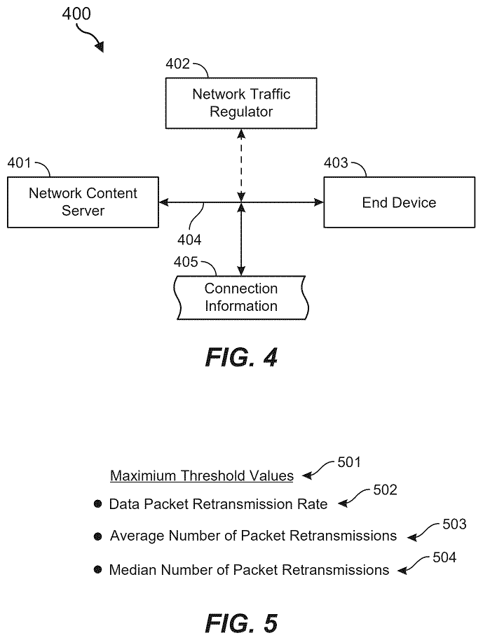

Indeed, as shown in embodiment 400 of FIG. 4, a network content server 401 is streaming data to (or has at least established a network connection with) end device 403. The connection 404 has various connection information 405 associated with it. For instance, at least in some embodiments, the connection information 405 indicates when the connection 404 started, how long the connection has been going, how much data has been transferred, the type of data being transferred, average packet size, protocol being used, or other information related to data transmission or reception for the connection 404. In some cases, if the data packet transmission rate is too high on the connection 404, a network traffic regulator 402 will take action and begin dropping packets from the network content server.

In some embodiments, the systems herein are configured to determine the amount of bandwidth at which data has been transferred on network connection 404. The amount of bandwidth may be measured in bits or bytes per second and may be an average value, a median value, a current value, or a historical value. In some cases, prior to determining, for the network connection 404, the amount of bandwidth at which data has been transferred, the systems herein determine that the network connection was previously labeled as being monitored by the network traffic regulator 402. This determination may indicate whether the network connection 404 has been problematic in the past, requiring a network traffic regulator 402 to step in and regulate the connection. This knowledge may result in changes to the token bucket size that are even larger than would normally be applied. That is, historical data is used to determine whether the connection has been problematic in the past and is further used to magnify the size of the changes in order to avoid future intrusions by the network traffic regulator 402. Moreover, at least in some cases, historical data from other network connections is used to provide initial inputs for connection parameters in new network connections.

In some cases, the systems herein access connection information 405 related to network connection 404 to determine when the network connection was started and/or to determine whether network traffic regulations had previously been enforced on the network connection. Like the example above, if historical network connection data indicates that at least some traffic changes had occurred, even if those changes fell short of involvement of a network traffic regulator, those changes may indicate that larger changes are to be made to the token bucket size to avoid intrusion by the network traffic regulator 402.

As shown in FIG. 5, the systems herein are configured to determine various maximum threshold values 501 for different network characteristics. For instance, in some embodiments, the systems herein determine a data packet retransmission rate 502 starting from a specified point in time. This point in time may be the start of the connection, a point in time X number of minutes ago, or some other time frame. The data packet retransmission rate 502 indicates the number of data packets that were retransmitted during that time (for whatever reason). The maximum threshold value 501 for data packet retransmission rate 502 is set based on previous connection data, based on previous connection changes, or based on previous involvement by the network traffic regulator 402. At least in some cases, the maximum threshold value 501 for data packet retransmission is dynamically determined based on the degree to which the network traffic regulator was involved, or the degree to which previous connection changes were made, or based on other previous connection data that would indicate that a larger or smaller change would be optimal.

Still further, in some cases, the systems herein determine a maximum threshold value 501 for the average number of times a data packet is retransmitted 503 on the network connection 404. As with the data packet retransmission rate 502, the average number of packet retransmissions 503 indicates the average number of data packets that were retransmitted since a specified time. The maximum threshold value 501 for average data packet retransmissions 503 is set based on previous connection data, based on previous connection changes, or based on previous involvement by the network traffic regulator 402. In some embodiments, the maximum threshold value 501 for average data packet retransmissions is dynamically determined based on the degree to which the network traffic regulator 402 interceded to drop packets, or the degree to which previous network connection changes were made, or based on other previous connection data that would indicate that a larger or smaller change would be preferable.

FIG. 5 also indicates that the median number of packet retransmissions 504 is optionally used as one of the maximum threshold values 501. This indicator defines the median number of times a data packet is retransmitted on the network connection 404 since the beginning of a specified time period. This median number of packet retransmissions may also be dynamically determined based on the same or similar factors. The maximum threshold value 501 for any of these three factors, or for other factors, is intended to specify a value above which a network traffic regulator (e.g., 402) is likely to get involved and drop packets on the connection 404. These threshold values, at least in some cases, are initially set at values that will allow operation free of involvement by the network traffic regulator and are later modified, in real time, to accommodate current network conditions or to accommodate different network traffic regulators.

In some embodiments, the systems herein compare the data packet retransmission rate 502, the average number of retransmissions 503, and the median number of retransmissions 504 to the previously established or dynamically updated maximum threshold values. If the values of one, two, or three of the measured connection values 502-504 are greater than the maximum threshold values, the systems herein will declare that the network connection is being regulated by a network traffic regulator. This declaration, in turn, will cause the token bucket size of the network connection to be adjusted downward, so that future data transfers on that connection do not trigger the network traffic regulator.

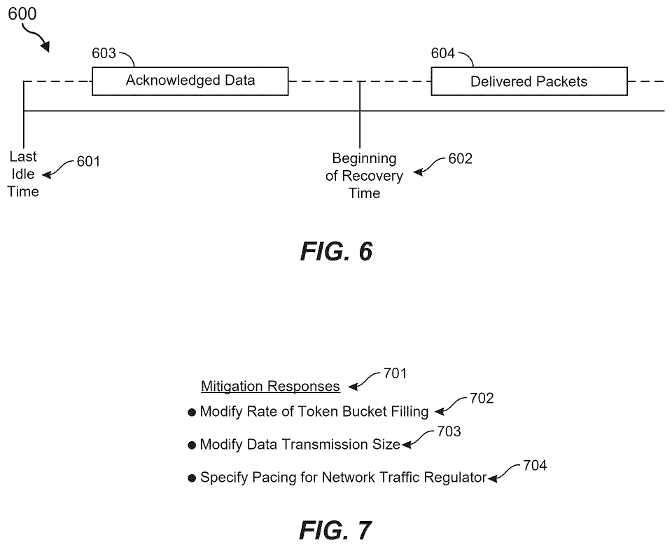

In some cases, as noted above, the systems herein look at the amount of data that has been acknowledged (e.g., using ACK or SACK messages) since a specified time. As shown in embodiment 600 of FIG. 6, the specified time may begin from a last idle time 601 or since the start of the connection. The amount of data that has been acknowledged 603 since the last idle time 601 is stored in corresponding network connection information. The systems herein also evaluate the number of data packets delivered 604 since the beginning of a recovery time 602. In some cases, the data that is acknowledged 603 includes network data starting from the last idle time 601 to the beginning of the recovery time 602.

In some cases, the systems herein are configured to validate that a minimum number of packets have been delivered 604 during the recovery time (starting at 602). This number of packets is then used when determining which mitigating actions to take to avoid involvement of a network traffic regulator. In some embodiments, mitigating actions may include updating the network transmission bucket maximum size. Additionally, in some cases, the network transmission bucket maximum size is updated to the amount of data that was acknowledged 603. In some examples, this further includes updating traffic regulator bandwidth to a value that allows a pacing timer to expire before a transmission round trip occurs (e.g., before a smoothed round trip time (SRTT) for the network data packets occurs).

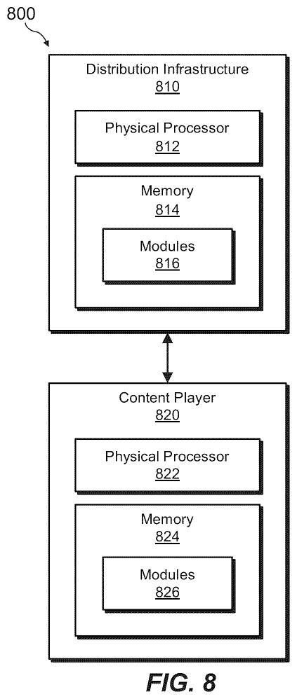

Additionally or alternatively, mitigating responses 701, as shown in FIG. 7, include modifying the rate of token bucket filling 702, modifying a data transmission size 703, or specifying pacing for a network traffic regulator 704. In the embodiments herein, modifying the rate of token bucket filling 702 includes increasing or decreasing the amount by which a token bucket for a given network connection will fill up. This amount is increased, for example, if the connection has shown no signs of interference by a network traffic regulator, allowing faster data transfer on the connection. That amount is decreased, though, if the connection has shown signs of interference by a network traffic regulator, to avoid future intrusions by the network traffic regulator.

Modifying the data transmission size 703 includes increasing or decreasing the size of the data packet bursts being transmitted by the server to the end device. In a similar vein, data transmission size 703 is increased if few or no signs of interference by a network traffic regulator have been detected. Data transmission size 703 is decreased if various signs of interference have been detected. Still further, specifying the pacing for a network traffic regulator 704 includes increasing or decreasing how often certain transmission-related tasks are performed to avoid intrusion by a network traffic regulator. Other mitigating actions may also be performed to reduce the number of incursions by a network traffic regulator on the network connection. In this manner, the systems herein can not only detect when and how much a network traffic regulator is likely to intrude on a connection but can also take actions to ensure that future incursions by the network traffic regulator are avoided.

In addition to the above-described method, a network system may be provided that includes a network adapter that transmits and receives data via a transport protocol, a memory device that at least temporarily stores data received at the network adapter, and a processor that processes at least some of the received data, including: determining, for a network connection, an amount of bandwidth at which data has been transferred starting from a specified point in time, identifying network heuristics related to occurrences of data packet retransmissions on the network connection since the specified point in time, determining, based on the network heuristics, that a maximum threshold value for data packet retransmissions has been exceeded, and updating a network transmission bucket maximum size to an amount of data that was acknowledged, using various acknowledgment (ACK) messages, since the specified point in time.

The embodiments herein also include a non-transitory computer-readable medium that includes computer-executable instructions that, when executed by at least one processor of a computing device, cause the computing device to: determine, for a network connection, an amount of bandwidth at which data has been transferred starting from a specified point in time, identify network heuristics related to occurrences of data packet retransmissions on the network connection since the specified point in time, determine, based on the network heuristics, that a maximum threshold value for data packet retransmissions has been exceeded, and update a network transmission bucket maximum size to an amount of data that was acknowledged, using various acknowledgment (ACK) messages, since the specified point in time.

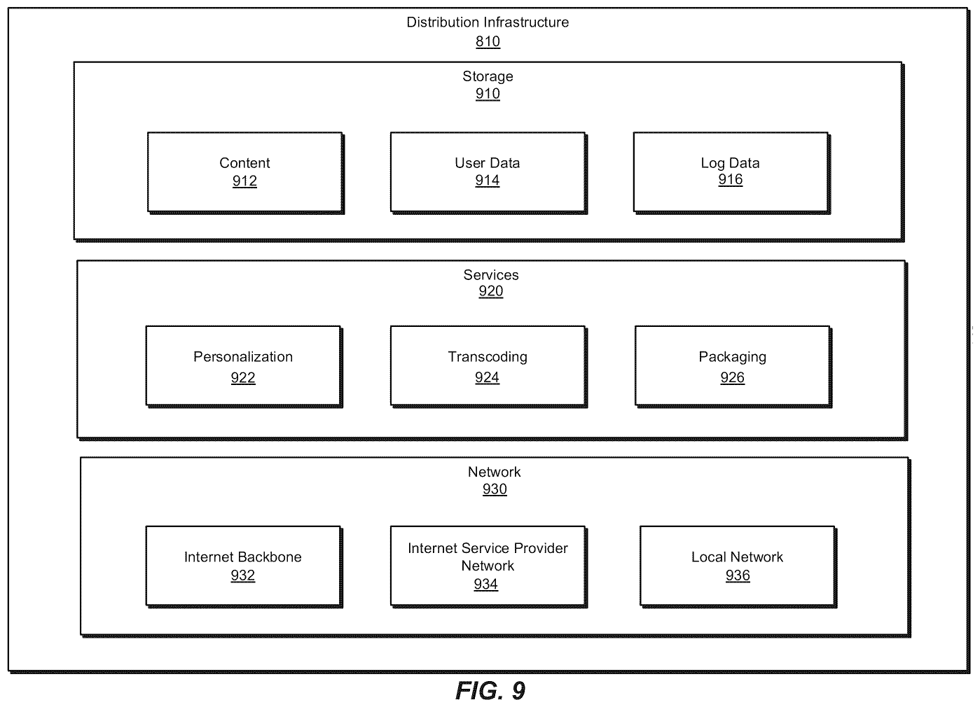

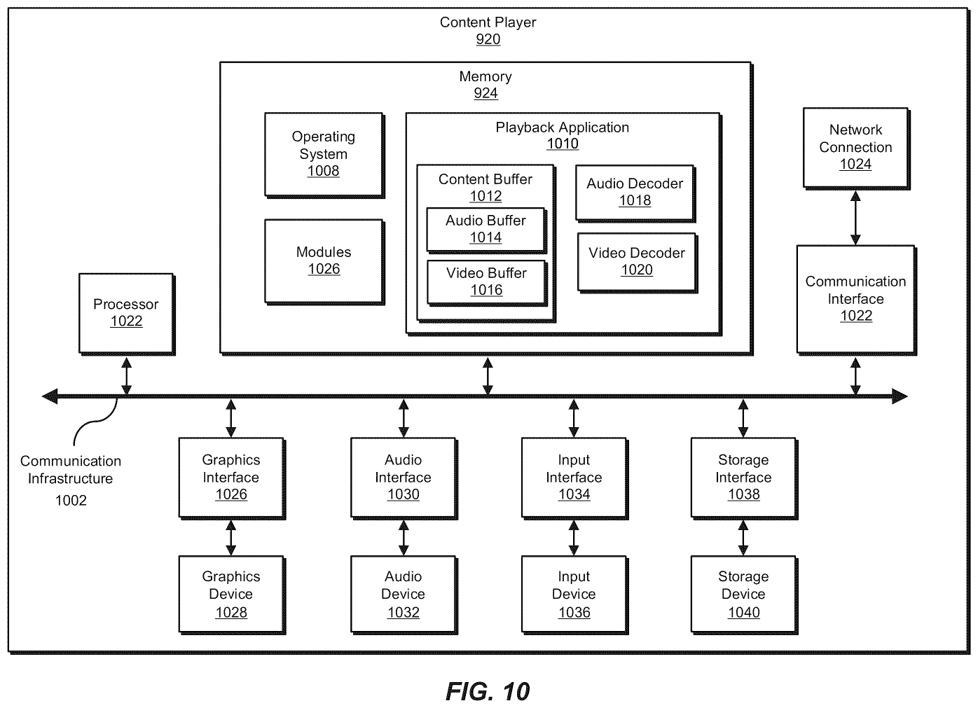

The following will provide, with reference to FIG. 8, detailed descriptions of exemplary ecosystems in which content is provisioned to end nodes and in which requests for content are steered to specific end nodes. The discussion corresponding to FIGS. 9 and 10 presents an overview of an exemplary distribution infrastructure and an exemplary content player used during playback sessions, respectively. These exemplary ecosystems and distribution infrastructures are implemented in any of the embodiments described above with reference to FIGS. 1-7.

FIG. 8 is a block diagram of a content distribution ecosystem 800 that includes a distribution infrastructure 810 in communication with a content player 820. In some embodiments, distribution infrastructure 810 is configured to encode data at a specific data rate and to transfer the encoded data to content player 820. Content player 820 is configured to receive the encoded data via distribution infrastructure 810 and to decode the data for playback to a user. The data provided by distribution infrastructure 810 includes, for example, audio, video, text, images, animations, interactive content, haptic data, virtual or augmented reality data, location data, gaming data, or any other type of data that is provided via streaming.

Distribution infrastructure 810 generally represents any services, hardware, software, or other infrastructure components configured to deliver content to end users. For example, distribution infrastructure 810 includes content aggregation systems, media transcoding and packaging services, network components, and/or a variety of other types of hardware and software. In some cases, distribution infrastructure 810 is implemented as a highly complex distribution system, a single media server or device, or anything in between. In some examples, regardless of size or complexity, distribution infrastructure 810 includes at least one physical processor 812 and at least one memory 814. One or more modules 816 are stored or loaded into memory 814 to enable adaptive streaming, as discussed herein.

Content player 820 generally represents any type or form of device or system capable of playing audio and/or video content that has been provided over distribution infrastructure 810. Examples of content player 820 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 810, content player 820 includes a physical processor 822, memory 824, and one or more modules 826. Some or all of the adaptive streaming processes described herein is performed or enabled by modules 826, and in some examples, modules 816 of distribution infrastructure 810 coordinate with modules 826 of content player 820 to provide adaptive streaming of multimedia content.

In certain embodiments, one or more of modules 816 and/or 826 in FIG. 8 represent one or more software applications or programs that, when executed by a computing device, cause the computing device to perform one or more tasks. For example, and as will be described in greater detail below, one or more of modules 816 and 826 represent modules stored and configured to run on one or more general-purpose computing devices. One or more of modules 816 and 826 in FIG. 8 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 812 and 822 generally represent any type or form of hardware-implemented processing unit capable of interpreting and/or executing computer-readable instructions. In one example, physical processors 812 and 822 access and/or modify one or more of modules 816 and 826, respectively. Additionally or alternatively, physical processors 812 and 822 execute one or more of modules 816 and 826 to facilitate adaptive streaming of multimedia content. Examples of physical processors 812 and 822 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 814 and 824 generally represent any type or form of volatile or non-volatile storage device or medium capable of storing data and/or computer-readable instructions. In one example, memory 814 and/or 824 stores, loads, and/or maintains one or more of modules 816 and 826. Examples of memory 814 and/or 824 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 810 according to certain embodiments. Distribution infrastructure 810 includes storage 910, services 920, and a network 930. Storage 910 generally represents any device, set of devices, and/or systems capable of storing content for delivery to end users. Storage 910 includes a central repository with devices capable of storing terabytes or petabytes of data and/or includes distributed storage systems (e.g., appliances that mirror or cache content at Internet interconnect locations to provide faster access to the mirrored content within certain regions). Storage 910 is also configured in any other suitable manner.

As shown, storage 910 may store a variety of different items including content 912, user data 914, and/or log data 916. Content 912 includes television shows, movies, video games, user-generated content, and/or any other suitable type or form of content. User data 914 includes personally identifiable information (PII), payment information, preference settings, language and accessibility settings, and/or any other information associated with a particular user or content player. Log data 916 includes viewing history information, network throughput information, and/or any other metrics associated with a user's connection to or interactions with distribution infrastructure 810.

Services 920 includes personalization services 922, transcoding services 924, and/or packaging services 926. Personalization services 922 personalize recommendations, content streams, and/or other aspects of a user's experience with distribution infrastructure 810. Encoding services 924 compress media at different bitrates which, as described in greater detail below, enable real-time switching between different encodings. Packaging services 926 package encoded video before deploying it to a delivery network, such as network 930, for streaming.

Network 930 generally represents any medium or architecture capable of facilitating communication or data transfer. Network 930 facilitates communication or data transfer using wireless and/or wired connections. Examples of network 930 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 930 includes an Internet backbone 932, an internet service provider 934, and/or a local network 936. As discussed in greater detail below, bandwidth limitations and bottlenecks within one or more of these network segments triggers video and/or audio bit rate adjustments.

FIG. 10 is a block diagram of an exemplary implementation of content player 820 of FIG. 8. Content player 820 generally represents any type or form of computing device capable of reading computer-executable instructions. Content player 820 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 822 and memory 824, content player 820 includes a communication infrastructure 1002 and a communication interface 1022 coupled to a network connection 1024. Content player 820 also includes a graphics interface 1026 coupled to a graphics device 1028, an input interface 1034 coupled to an input device 1036, and a storage interface 1038 coupled to a storage device 1040.

Communication infrastructure 1002 generally represents any type or form of infrastructure capable of facilitating communication between one or more components of a computing device. Examples of communication infrastructure 1002 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 stores and/or loads an operating system 1008 for execution by processor 822. In one example, operating system 1008 includes and/or represents software that manages computer hardware and software resources and/or provides common services to computer programs and/or applications on content player 820.

Operating system 1008 performs various system management functions, such as managing hardware components (e.g., graphics interface 1026, audio interface 1030, input interface 1034, and/or storage interface 1038). Operating system 1008 also provides process and memory management models for playback application 1010. The modules of playback application 1010 includes, for example, a content buffer 1012, an audio decoder 1018, and a video decoder 1020.

Playback application 1010 is configured to retrieve digital content via communication interface 1022 and play the digital content through graphics interface 1026. Graphics interface 1026 is configured to transmit a rendered video signal to graphics device 1028. In normal operation, playback application 1010 receives a request from a user to play a specific title or specific content. Playback application 1010 then identifies one or more encoded video and audio streams associated with the requested title. After playback application 1010 has located the encoded streams associated with the requested title, playback application 1010 downloads sequence header indices associated with each encoded stream associated with the requested title from distribution infrastructure 810. A sequence header index associated with encoded content includes information related to the encoded sequence of data included in the encoded content.

In one embodiment, playback application 1010 begins downloading the content associated with the requested title by downloading sequence data encoded to the lowest audio and/or video playback bitrates to minimize startup time for playback. The requested digital content file is then downloaded into content buffer 1012, which is configured to serve as a first-in, first-out queue. In one embodiment, each unit of downloaded data includes a unit of video data or a unit of audio data. As units of video data associated with the requested digital content file are downloaded to the content player 820, the units of video data are pushed into the content buffer 1012. Similarly, as units of audio data associated with the requested digital content file are downloaded to the content player 820, the units of audio data are pushed into the content buffer 1012. In one embodiment, the units of video data are stored in video buffer 1016 within content buffer 1012 and the units of audio data are stored in audio buffer 1014 of content buffer 1012.

A video decoder 1020 reads units of video data from video buffer 1016 and outputs the units of video data in a sequence of video frames corresponding in duration to the fixed span of playback time. Reading a unit of video data from video buffer 1016 effectively de-queues the unit of video data from video buffer 1016. The sequence of video frames is then rendered by graphics interface 1026 and transmitted to graphics device 1028 to be displayed to a user.

An audio decoder 1018 reads units of audio data from audio buffer 1014 and output the units of audio data as a sequence of audio samples, generally synchronized in time with a sequence of decoded video frames. In one embodiment, the sequence of audio samples is transmitted to audio interface 1030, which converts the sequence of audio samples into an electrical audio signal. The electrical audio signal is then transmitted to a speaker of audio device 1032, which, in response, generates an acoustic output.

In situations where the bandwidth of distribution infrastructure 810 is limited and/or variable, playback application 1010 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1026 is configured to generate frames of video data and transmit the frames of video data to graphics device 1028. In one embodiment, graphics interface 1026 is included as part of an integrated circuit, along with processor 822. Alternatively, graphics interface 1026 is configured as a hardware accelerator that is distinct from (i.e., is not integrated within) a chipset that includes processor 822.

Graphics interface 1026 generally represents any type or form of device configured to forward images for display on graphics device 1028. For example, graphics device 1028 is fabricated using liquid crystal display (LCD) technology, cathode-ray technology, and light-emitting diode (LED) display technology (either organic or inorganic). In some embodiments, graphics device 1028 also includes a virtual reality display and/or an augmented reality display. Graphics device 1028 includes any technically feasible means for generating an image for display. In other words, graphics device 1028 generally represents any type or form of device capable of visually displaying information forwarded by graphics interface 1026.

As illustrated in FIG. 10, content player 820 also includes at least one input device 1036 coupled to communication infrastructure 1002 via input interface 1034. Input device 1036 generally represents any type or form of computing device capable of providing input, either computer or human generated, to content player 820. Examples of input device 1036 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 820 also includes a storage device 1040 coupled to communication infrastructure 1002 via a storage interface 1038. Storage device 1040 generally represents any type or form of storage device or medium capable of storing data and/or other computer-readable instructions. For example, storage device 1040 is a magnetic disk drive, a solid-state drive, an optical disk drive, a flash drive, or the like. Storage interface 1038 generally represents any type or form of interface or device for transferring data between storage device 1040 and other components of content player 820.

Many other devices or subsystems are included in or connected to content player 820. Conversely, one or more of the components and devices illustrated in FIG. 10 need not be present to practice the embodiments described and/or illustrated herein. The devices and subsystems referenced above are also interconnected in different ways from that shown in FIG. 10. Content player 820 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 820. All or a portion of the computer program stored on the computer-readable medium is then stored in memory 824 and/or storage device 1040. When executed by processor 822, a computer program loaded into memory 824 causes processor 822 to perform and/or be a means for performing the functions of one or more of the example embodiments described and/or illustrated herein. Additionally or alternatively, one or more of the example embodiments described and/or illustrated herein are implemented in firmware and/or hardware. For example, content player 820 is configured as an Application Specific Integrated Circuit (ASIC) adapted to implement one or more of the example embodiments disclosed herein.

### EXAMPLE EMBODIMENTS

Example 1: A computer-implemented method includes determining, for a network connection, an amount of bandwidth at which data has been transferred starting from a specified point in time, identifying one or more network heuristics related to occurrences of data packet retransmissions on the network connection since the specified point in time, determining, based on the one or more network heuristics, that a maximum threshold value for data packet retransmissions has been exceeded, and updating a network transmission bucket maximum size to an amount of data that was acknowledged, using one or more acknowledge (ACK) messages, since the specified point in time.

Example 2: The computer-implemented method of Example 1, wherein, prior to determining, for the network connection, the amount of bandwidth at which data has been transferred, determining that the network connection was previously labeled as being monitored by a network traffic regulator.

Example 3: The computer-implemented method of Example 1 or Example 2, further comprising accessing information related to the network connection, the information including at least an indication of when the network connection was started or an indication of whether network traffic regulations had previously been enforced on the network connection.

Example 4: The computer-implemented method of any of Examples 1-3, further comprising determining at least one of: a data packet retransmission rate starting from the specified point in time, an average number of times a data packet is being retransmitted on the network connection, or a median number of times a data packet is being retransmitted on the network connection.

Example 5: The computer-implemented method of any of Examples 1-4, wherein maximum threshold values are established for the data packet retransmission rate, the average number of retransmissions, and the median number of retransmissions.

Example 6: The computer-implemented method of any of Examples 1-5, further comprising comparing the data packet retransmission rate, the average number of retransmissions, and the median number of retransmissions to the corresponding maximum threshold values, and, upon determining that at least two are greater than maximum threshold values, declaring that the network connection is being regulated by a network traffic regulator.

Example 7: The computer-implemented method of any of Examples 1-6, wherein the data that was acknowledged comprises network data starting from a last idle time to the beginning of a recovery time.

Example 8: The computer-implemented method of any of Examples 1-7, further comprising validating that a set number of packets have been delivered during the recovery time.

Example 9: The computer-implemented method of any of Examples 1-8, wherein updating the network transmission bucket maximum size to the amount of data that was acknowledged comprises updating traffic regulator bandwidth to a value that allows a pacing timer to expire before a transmission round trip occurs.

Example 10: The computer-implemented method of any of Examples 1-9, wherein the transmission round trip comprises a smoothed round trip time (SRTT) for the network data packets.

Example 11: The computer-implemented method of any of Examples 1-10, further comprising mitigating data packet retransmission by modifying a rate of token bucket filling, by modifying a data transmission size, or by specifying a pacing for a network traffic regulator.

Example 12: The computer-implemented method of any of Examples 1-11, wherein the network connection transmits the data packets using at least one transport protocol.

Example 13: A network computing system includes: a network adapter that transmits and receives data via a transport protocol, a memory device that at least temporarily stores data received at the network adapter, and a processor that processes at least some of the received data, including: determining, for a network connection, an amount of bandwidth at which data has been transferred starting from a specified point in time, identifying one or more network heuristics related to occurrences of data packet retransmissions on the network connection since the specified point in time, determining, based on the one or more network heuristics, that a maximum threshold value for data packet retransmissions has been exceeded, and updating a network transmission bucket maximum size to an amount of data that was acknowledged, using one or more acknowledge (ACK) messages, since the specified point in time.

Example 14: The network computing system of Example 13, further comprising determining at least one of: a data packet retransmission rate starting from the specified point in time, an average number of times a data packet is being retransmitted on the network connection, or a median number of times a data packet is being retransmitted on the network connection.

Example 15: The network computing system of Example 13 or Example 14, wherein maximum threshold values are established for the data packet retransmission rate, the average number of retransmissions, and the median number of retransmissions.

Example 16: The network computing system of any of Examples 13-15, further comprising comparing the data packet retransmission rate, the average number of retransmissions, and the median number of retransmissions to the corresponding maximum threshold values, and, upon determining that at least two are greater than maximum threshold values, declaring that the network connection is being regulated by a network traffic regulator.

Example 17: The network computing system of any of Examples 13-16, wherein updating the network transmission bucket maximum size to the amount of data that was acknowledged comprises updating traffic regulator bandwidth to a value that allows a pacing timer to expire before a transmission round trip occurs.

Example 18: The network computing system of any of Examples 13-17, wherein the transmission round trip comprises a smoothed round trip time (SRTT) for the network data packets.

Example 19: The network computing system of any of Examples 13-18, further comprising mitigating data packet retransmission by modifying a rate of token bucket filling, by modifying a data transmission size, or by specifying a pacing for a network traffic regulator.

Example 20: A non-transitory computer-readable medium comprising one or more computer-executable instructions that, when executed by at least one processor of a computing device, cause the computing device to: determine, for a network connection, an amount of bandwidth at which data has been transferred starting from a specified point in time, identify one or more network heuristics related to occurrences of data packet retransmissions on the network connection since the specified point in time, determine, based on the one or more network heuristics, that a maximum threshold value for data packet retransmissions has been exceeded, and update a network transmission bucket maximum size to an amount of data that was acknowledged, using one or more acknowledge (ACK) messages, since the specified point in time.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation to apply a heuristic, use the result of the transformation to identify a security threat, and store the result of the transformation to identify future security threats. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.’

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

We claim:

1. A computer-implemented method comprising:
determining, for a network connection, an amount of bandwidth at which data has been transferred starting from a specified point in time;
identifying one or more network heuristics related to occurrences of data packet retransmissions on the network connection since the specified point in time;
determining, based on the one or more network heuristics, that a maximum threshold value for data packet retransmissions has been exceeded; and
updating a network transmission bucket maximum size to an amount of data that was acknowledged, using one or more acknowledgment (ACK) messages, since the specified point in time.

2. The computer-implemented method of claim 1, wherein, prior to determining, for the network connection, the amount of bandwidth at which data has been transferred, determining that the network connection was previously labeled as being monitored by a network traffic regulator.

3. The computer-implemented method of claim 1, further comprising accessing information related to the network connection, the information including at least an indication of when the network connection was started or an indication of whether network traffic regulations had previously been enforced on the network connection.

4. The computer-implemented method of claim 1, further comprising determining at least one of:
a data packet retransmission rate starting from the specified point in time;
an average number of times a data packet is being retransmitted on the network connection;
a moving average number of times a data packet is being retransmitted on the network connection, the moving average being determined over a specified amount of time; or
a median number of times a data packet is being retransmitted on the network connection.

5. The computer-implemented method of claim 4, wherein maximum threshold values are established for the data packet retransmission rate, the average number of retransmissions, and the median number of retransmissions.

6. The computer-implemented method of claim 5, further comprising comparing the data packet retransmission rate, the average number of retransmissions, and the median number of retransmissions to the corresponding maximum threshold values, and, upon determining that at least two are greater than maximum threshold values, declaring that the network connection is being regulated by a network traffic regulator.

7. The computer-implemented method of claim 1, wherein the data that was acknowledged comprises network data starting from a specified idle time to the beginning of a recovery time.

8. The computer-implemented method of claim 7, further comprising validating that a minimum number of packets have been delivered during the recovery time.

9. The computer-implemented method of claim 1, wherein updating the network transmission bucket maximum size to the amount of data that was acknowledged comprises updating traffic regulator bandwidth to a value that allows a pacing timer to expire before a transmission round trip occurs.

10. The computer-implemented method of claim 9, wherein the transmission round trip comprises a specified round trip time estimate for the network data packets.

11. The computer-implemented method of claim 1, further comprising mitigating data packet retransmission by modifying a rate of token bucket filling, by modifying a data transmission size, or by specifying a pacing rate for a network traffic regulator.

12. The computer-implemented method of claim 1, wherein the network connection transmits the data packets using at least one communications protocol.

13. A network computing system, comprising:
a network adapter that transmits and receives data via a communications protocol;
a memory device that at least temporarily stores data received at the network adapter; and
a processor that processes at least some of the received data, including:
determining, for a network connection, an amount of bandwidth at which data has been transferred starting from a specified point in time;
identifying one or more network heuristics related to occurrences of data packet retransmissions on the network connection since the specified point in time;
determining, based on the one or more network heuristics, that a maximum threshold value for data packet retransmissions has been exceeded; and
updating a network transmission bucket maximum size to an amount of data that was acknowledged, using one or more acknowledgment (ACK) messages, since the specified point in time.

14. The network computing system of claim 13, further comprising determining at least one of:
a data packet retransmission rate starting from the specified point in time;
an average number of times a data packet is being retransmitted on the network connection; or
a median number of times a data packet is being retransmitted on the network connection.

15. The network computing system of claim 14, wherein maximum threshold values are established for the data packet retransmission rate, the average number of retransmissions, and the median number of retransmissions.

16. The network computing system of claim 15, further comprising comparing the data packet retransmission rate, the average number of retransmissions, and the median number of retransmissions to the corresponding maximum threshold values, and, upon determining that at least two are greater than maximum threshold values, declaring that the network connection is being regulated by a network traffic regulator.

17. The network computing system of claim 13, wherein updating the network transmission bucket maximum size to the amount of data that was acknowledged comprises updating traffic regulator bandwidth to a value that allows a pacing timer to expire before a transmission round trip occurs.

18. The network computing system of claim 17, wherein the transmission round trip comprises a smoothed round trip time (SRTT) for the network data packets.

19. The network computing system of claim 13, further comprising mitigating data packet retransmission by modifying a rate of token bucket filling, by modifying a data transmission size, or by specifying a pacing rate for a network traffic regulator.

20. A non-transitory computer-readable medium comprising one or more computer-executable instructions that, when executed by at least one processor of a computing device, cause the computing device to:
determine, for a network connection, an amount of bandwidth at which data has been transferred starting from a specified point in time;
identify one or more network heuristics related to occurrences of data packet retransmissions on the network connection since the specified point in time;
determine, based on the one or more network heuristics, that a maximum threshold value for data packet retransmissions has been exceeded; and
update a network transmission bucket maximum size to an amount of data that was acknowledged, using one or more acknowledgment (ACK) messages, since the specified point in time.
